(19) United States
(12) Patent Application Publication
(10) Pub. No.: US 2003/0232722 A1
(43) Pub. Date: Dec. 18, 2003

(54) Carbon dioxide gas absorbent, method for manufacturing the carbon dioxide gas absorbent and method of regenerating the carbon dioxide gas absorbent

(75) Inventors: Masahiro Kato, Kanagawa-ken (JP); Sawako Yoshikawa, Kanagawa-ken (JP); Kenji Essaki, Kanagawa-ken (JP); Kazuaki Nakagawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/379,907

(22) Filed: Mar. 6, 2003

(30) Foreign Application Priority Data
Sep. 19, 2002 (JP) 2002-272849
Mar. 6, 2002 (JP) 2002-059736

(51) Int. Cl. B01J 20/04

(52) U.S. Cl. 502/411; 502/55

(57) ABSTRACT

One embodiment of the present invention provides a carbon dioxide gas absorbent, which includes at least one compound selected from the group including sodium silicate, potassium silicate, and a combination thereof; and lithium silicate. Another embodiment of the present invention provides A carbon dioxide gas absorbent, which includes at least one compound selected from the group including sodium-based anhydrous water glass, potassium-based anhydrous water glass, and a combination thereof; and lithium silicate. The present invention also provides for methods of making the absorbents and methods of using same.

### CROSS-REFERENCE TO RELATED APPLICATIONS

This application is based upon and claims the benefit of priority from Japanese Patent Application Nos. 2002-272849 filed Sep. 19, 2002, and 2002-059736, filed Mar. 6, 2002, the entire contents of each of which are incorporated herein by reference.

### BACKGROUND OF THE INVENTION

1. Field of the Invention

The invention relates to a carbon dioxide gas absorbent, method for manufacturing the same, and method of regenerating the same.

2. Discussion of the Background

Fuels containing hydrocarbons as the main components are combusted in combustion apparatuses. Examples of such combustion apparatuses include, for example, engines. The exhaust gas discharged from such combustion apparatuses contains carbon dioxide gas. Carbon dioxide gas is separated and recovered from the exhaust gas. The separation and recovery of carbon dioxide gas is effective when performed in the vicinity of the combustion chamber of the combustion apparatus where the carbon dioxide gas concentration is high. The temperature in the vicinity of the combustion chamber is high, generally about 300° C. or higher.

Known methods for separating carbon dioxide gas include a method using cellulose acetate, a chemical absorption method using alkanolamine based solvent, and the like. These methods require the exhaust gas to be set at a temperature of about 200° C. or lower. Since the exhaust gas emitted from the combustion apparatus is high in temperature, the exhaust gas is required to cool to about 200° C. or lower by using a heat exchanger and the like. Cooling the exhaust gas for the carbon dioxide gas separation is problematic in that it consumes a great deal of energy.

Other methods of carbon dioxide gas separation include a method using a carbon dioxide gas absorbent containing lithium zirconate (see for example Japanese Patent Publication (Kokai) No. 9-99214) or a method using a carbon dioxide gas absorbent containing lithium silicate (see for example Japanese Patent Publication (Kokai) No. 2000-262890). The carbon dioxide gas absorbents that contain lithium zirconate or lithium silicate can absorb carbon dioxide gas in a temperature range of from room temperature to over 500° C. These carbon dioxide gas absorbents desorb carbon dioxide gas at about 600° C. or higher. These carbon dioxide gas absorbents can repeatedly absorb and desorb carbon dioxide gas. Furthermore, the addition of alkali carbonate selected from sodium carbonate and potassium carbonate to these carbon dioxide gas absorbents accelerates the absorption reaction of carbon dioxide (see for example Japanese Patent Publication (Kokai) No. 2001-170480).

When carbon dioxide gas absorbents containing lithium zirconate or lithium silicate repeatedly absorb and desorb carbon dioxide, however, a gradual decrease in the amount of carbon dioxide gas absorption occurs. Hence, it is difficult to stably achieve favorable carbon dioxide gas absorption properties over long periods of time.

### SUMMARY OF THE INVENTION

Accordingly, one object of the present invention is to provide a carbon dioxide gas absorbent, which exhibits favorable carbon dioxide absorption characteristics stably over long periods of time, a method for manufacturing same, and a method for regenerating same.

### BRIEF DESCRIPTION OF THE FIGURES

Various other objects, features and attendant advantages of the present invention will be more fully appreciated as the same becomes better understood from the following detailed description in connection with the accompanying drawings in which like reference characters designate like or corresponding parts throughout the several views and wherein:

FIG. 1 is a schematic view showing the surface of a carbon dioxide gas absorbent according to example 1 of the invention.

FIG. 2 is a schematic view showing the surface of a carbon dioxide gas absorbent according to example 17 of the invention.

FIG. 3 is an explanatory diagram showing a carbon dioxide gas absorption tube according to one embodiment of the invention.

FIG. 4 is an explanatory diagram showing the apparatus for evaluating carbon dioxide gas absorption performance according to one embodiment of the invention.

### DESCRIPTION OF THE PREFERRED EMBODIMENTS

Various other objects, features and attendant advantages of the present invention will be more fully appreciated as the same becomes better understood from the following detailed description of the preferred embodiments of the invention.

According to a first aspect or preferred embodiment of the present invention, there is provided a carbon dioxide gas absorbent, which includes:

at least one element selected from the group including sodium silicate, potassium silicate; and

lithium silicate.

According to a second aspect or preferred embodiment of the present invention, there is provided a carbon dioxide gas absorbent, which includes:

at least one element selected from the group including sodium-based anhydrous water glass, potassium-based anhydrous water glass; and

lithium silicate.

According to a third aspect or preferred embodiment of the present invention, there is provided a method of manufacturing a carbon dioxide absorbent, which includes:

mixing lithium carbonate and silicon dioxide to form a first mixture;

mixing the first mixture and a solution to form a second mixture, wherein the solution includes at least one element selected from the group including sodium-based anhydrous water glass, potassium-based anhydrous water glass;

forming a pellet, a granule, or a film from the second mixture; and heating the pellet, the granule, or the film.

According to a fourth aspect or preferred embodiment of the present invention, there is provided a method of manufacturing a carbon dioxide absorbent, which includes:

mixing lithium carbonate and silicon dioxide to form a first mixture;

heating the first mixture;

mixing the first mixture and a solution to form a second mixture after heating, wherein the solution includes at least one element selected from the group including sodium-based anhydrous water glass, potassium-based anhydrous water_glass; and

forming a pellet, a granule, or a film from the second mixture.

According to a fifth aspect or preferred embodiment of the present invention, there is provided a method of regenerating a carbon dioxide gas absorbent after the carbon dioxide gas absorbent absorbing carbon dioxide gas, wherein the carbon dioxide gas absorbent includes at least one element selected from the group including sodium silicate, potassium silicate; and lithium silicate comprising:

heating the carbon dioxide gas absorbent in a temperature of 350° C. to 1000° C.;

cooling the carbon dioxide gas absorbent in an atmosphere which does not contain carbon dioxide gas; and

humidifying the carbon dioxide gas absorbent in an atmosphere which contains water vapor, and does not contain carbon dioxide gas, wherein water in the carbon dioxide gas absorbent is not less than 0.5 wt %.

A carbon dioxide gas absorbent (1) according to an embodiment of the invention includes lithium silicate and at least one selected from the group including sodium silicate and potassium silicate. Another carbon dioxide gas absorbent (2) according to another embodiment of the invention includes lithium silicate and at least one selected from the group including sodium-based anhydrous water glass and potassium-based anhydrous water glass.

Another embodiment of the present invention provides a method for using the carbon dioxide gas absorbent, which includes contacting the carbon dioxide gas absorbent with carbon dioxide gas.

Another embodiment of the present invention provides an article which includes the carbon dioxide gas absorbent and a support or container. Some examples of a container and/or support include a cannister, a filter, paper, cloth, tube, manifold, pipe, exhaust pipe, mesh, cartridge, scrubber, and the like.

A method (1) for manufacturing carbon dioxide gas absorbent according to an embodiment of the invention includes a first mixing step for obtaining a first mixture by mixing lithium carbonate with silicon dioxide; a second mixing step for obtaining a second mixture by adding and mixing with the first mixture, an aqueous solution containing at least one selected from the group including sodium silicate and potassium silicate; a step of subjecting the second mixture to molding, granulating, or coating a substrate; and a heat treatment step of thermally treating the second mixture after the step of molding, granulating, or coating.

Further, a method (2) for manufacturing carbon dioxide gas absorbent according to an embodiment of the invention includes a first mixing step for obtaining a first mixture by mixing lithium carbonate with silicon dioxide; a second mixing step for obtaining a second mixture by adding and mixing with the first mixture, an aqueous solution containing at least one selected from the group including sodium-based anhydrous water glass and potassium-based anhydrous water glass; a step of subjecting the second mixture to molding, granulating, or coating a substrate; and a heat treatment step of thermally treating the second mixture after the step of molding, granulating, or coating.

The present inventors have studied the cause of lowering the carbon dioxide gas absorption performance of the carbon dioxide gas absorbent. The manufacturing process of a carbon dioxide gas absorbent includes heat treating the carbon dioxide gas absorbent. A carbon dioxide gas absorbent absorbs and desorbs carbon dioxide gas at high temperatures. It has been found that grain growth occurs on the carbon dioxide gas absorbent in case heat treatment is applied to a carbon dioxide gas absorbent, or in case the carbon dioxide gas absorbent absorbs and desorbs carbon dioxide gas. In particular, carbon dioxide gas absorbent desorbs carbon dioxide gas at a high temperature region, and distinguished grain growth occurs on the carbon dioxide gas absorbent at this point. The carbon dioxide gas absorbent is prepared as a porous material, and contains numerous pores. When the carbon dioxide gas absorbent undergoes grain growth, the pores of the carbon dioxide gas absorbent decrease in number to cause clogging, or the surface area of the carbon dioxide gas absorbent decreases. In this manner, the carbon dioxide gas absorption properties become impaired.

The carbon dioxide gas absorbent (1) according to an embodiment of the invention includes sodium silicate or potassium silicate in addition to lithium silicate. During the heat treatment step, sodium silicate or potassium silicate, which is in the form of small solid particles, is interposed among the carbon dioxide gas absorbent and the particles of the raw materials of the carbon dioxide gas absorbent. Thus, sodium silicate or potassium silicate provides the so-called pinning effect, an effect of decreasing the contact area among the particles of the carbon dioxide gas absorbent and the particles of the raw materials. In this manner, sodium silicate or potassium silicate suppresses the grain growth of carbon dioxide gas absorbents by the pinning effect.

Sodium silicate or potassium silicate is crystalline at high temperatures at which the carbon dioxide gas desorption reaction and the like take place. Sodium silicate or potassium silicate in crystalline state increases the strength of the carbon dioxide gas absorbent at high temperatures. Sodium silicate or potassium silicate in crystalline state maintains the shape of the carbon dioxide gas absorbent at high temperatures.

Lithium carbonate is produced on the surface of the carbon dioxide gas absorbent by the reaction with carbon dioxide, forming a layer around the carbon dioxide gas absorbent. Since the melting point of lithium carbonate is 730° C., which is much higher than the absorption temperature of carbon dioxide gas, the solid layer of lithium carbonate hinders further reaction in the absence of sodium silicate or potassium silicate. On the other hand, the carbon dioxide gas absorbent having a certain amount of sodium silicate or potassium silicate produces a mixture which has lower melting point than lithium carbonate, and this mixture forms a liquid phase. The liquid phase accelerates the diffusion of carbon dioxide gas into the inside of the carbon dioxide gas absorbent. In this manner, the carbon dioxide gas absorption properties are improved.

Sodium silicate can be expressed by chemical formulae such as Na₂SiO₃, Na₂Si₂O₅, Na₄SiO₄, and the like. Potassium silicate can be expressed by chemical formulae such as K₂SiO₃, K₂Si₂O₅, K₂Si₄O₉, and the like. The actual composition may somewhat differ from the stoichiometric ratio expressed by these formulae.

The carbon dioxide gas absorbent (2) according to another embodiment of the invention includes as the carbon dioxide gas absorbent, in addition to lithium silicate, sodium-based anhydrous water glass or potassium-based anhydrous water glass. During the heat treatment step, the sodium-based anhydrous water glass or potassium-based anhydrous water glass, which is in glassy state, partly covers the surface of the particles of carbon dioxide gas absorbent or the particles of the raw materials of the carbon dioxide gas absorbent thereof. Sodium-based anhydrous water glass or potassium-based anhydrous water glass provides the so-called pinning effect, an effect of decreasing the contact area among the particles of the carbon dioxide gas absorbent and the particles of the raw materials. In this manner, sodium-based anhydrous water glass or potassium-based anhydrous water glass suppresses the grain growth of carbon dioxide gas absorbents by the pinning effect.

Sodium-based anhydrous water glass or potassium-based anhydrous water glass makes contact with the particles of carbon dioxide gas absorbent or the particles of raw materials. Since anhydrous water glass is interposed, the contact area between the particles increases. This leads to an increase in binding force among the particles of the carbon dioxide gas absorbent and the particles of the raw materials. Anhydrous water glass maintains the shape of the carbon dioxide gas absorbent in the form of pellets, granules, or films.

The carbon dioxide gas absorbent forms lithium carbonate on absorbing carbon dioxide gas. Sodium-based anhydrous water glass or potassium-based anhydrous water glass reacts with lithium carbonate to form a liquid phase. The liquid phase accelerates the diffusion of carbon dioxide gas into the inside of the carbon dioxide gas absorbent. In this manner, the carbon dioxide gas absorption properties are improved.

Sodium-based anhydrous water glass can be expressed by chemical formulae such as Na₂O-n(SiO₂) (2≦n≦4) and the like. Potassium-based anhydrous water glass can be expressed by chemical formulae such as K₂O-n(SiO₂)(2≦n≦4) and the like. The actual composition may somewhat differ from the stoichiometric ratio expressed by these formulae. Anhydrous water glass is soluble to water. Anhydrous water glass may be dissolved in water under the atmosphere at a temperature such as room temperature. Otherwise, anhydrous water glass may be dissolved under high temperature and pressure. Each of the above range includes all values including 2, 2.1, 2.3, 2.5, 2.7, 2.9, 3, 3.1, 3.3, 3.5, 3.7, and 3.9.

The carbon dioxide gas absorbent (2) according to another embodiment of the invention may further contain at least one element selected from sodium silicate and potassium silicate. The carbon dioxide gas absorbent containing sodium-based anhydrous water glass or potassium-based anhydrous water glass is heat treated during its production. During the heat treatment, a part of sodium-based anhydrous water glass or potassium-based anhydrous water glass may sometimes crystallize to form sodium silicate or potassium silicate. The carbon dioxide gas absorbent on which a part of sodium-based anhydrous water glass or potassium-based anhydrous water glass is crystallized has the pinning effect or the effect of increasing carbon dioxide gas absorption properties. Sodium silicate or potassium silicate shows high strength at high temperatures. Sodium-based anhydrous water glass or potassium-based anhydrous water glass exerts strong binding force on the particles of carbon dioxide gas absorbent. The carbon dioxide gas absorbent in which a part of sodium-based anhydrous water glass or potassium-based anhydrous water glass is crystallized exhibits high strength at high temperatures and high binding force.

The carbon dioxide gas absorbent containing sodium-based anhydrous water glass or potassium-based anhydrous water glass is heat treated during its production. In case the heat treatment is performed at a high temperature of about 700° C. or higher or for time duration of about 8 hours or longer, a part of sodium-based anhydrous water glass or potassium-based anhydrous water glass tends to crystallize and forms sodium silicate or potassium silicate, respectively.

At least one element selected from sodium silicate and potassium silicate, or at least one element selected from sodium-based anhydrous water glass and potassium-based anhydrous water glass is contained in the carbon dioxide gas absorbent in a preferable amount of about 1 mol % or higher but not more than about 40 mol %, and more preferably, about 5 mol % or higher but not more than about 30 mol %. When the quantity of sodium silicate or potassium silicate, or sodium-based anhydrous water glass or potassium-based anhydrous water glass incorporated in the carbon dioxide gas absorbent is less than 1 mol %, the effect of improving carbon dioxide gas absorption properties or the pinning effect is small. When the quantity of sodium silicate or potassium silicate, or sodium-based anhydrous water glass or potassium-based anhydrous water glass incorporated in the carbon dioxide gas absorbent exceeds about 40 mol %, the effect of improving carbon dioxide gas absorption properties or the pinning effect becomes saturated. Furthermore, the quantity of lithium silicate contained in the carbon dioxide gas absorbent decreases as to impair the carbon dioxide gas absorbent absorption properties. The above ranges include all values and subranges therebetween, including 2, 3, 4, 5, 6, 7, 8, 9, 10, 12, 14, 16, 18, 20, 22, 24, 26, 28, 30, 31, 32, 33, 34, 35, 36, 37, 38 and 39 mol %.

Usable lithium silicate includes lithium metasilicate (Li₂SiO₃) or lithium orthosilicate (Li₄SiO₄), or such expressed by the formulae Li₆Si₂O₇, Li₈SiO₆, and the like. Lithium orthosilicate is most preferred because it exhibits high carbon dioxide gas absorption characteristics. The actual composition may somewhat differ from the stoichiometric ratio expressed by these formulae.

The carbon dioxide gas absorbent may further contain added therein at least one type of alkali carbonate selected from the group including lithium carbonate, sodium carbonate, and potassium carbonate. In case the carbon dioxide gas absorbent absorbs carbon dioxide gas, solid lithium carbonate forms on the surface of the carbon dioxide gas absorbent. Since the alkali carbonates lower melting points, the alkali carbonates form liquid phases of lithium carbonate on absorption and desorption of carbon dioxide gas by the carbon dioxide gas absorbent at high temperatures. The liquid phase increases the rate of diffusing carbon dioxide gas on the surface of the carbon dioxide gas absorbent. The liquid phase improves the carbon dioxide gas absorption characteristics.

The alkali carbonate that wets the surface of the carbon dioxide gas absorbent generates a state in which carbon dioxide gas is easily absorbed by the carbon dioxide gas absorbent. However, the alkali carbonate in liquid phase wets the surface of the surrounding carbon dioxide gas absorbent as to lower the surface energy. The particles lowered in surface energy may undergo grain growth. The embodiment according to the invention is preferred, because, since sodium silicate or potassium silicate, or sodium-based anhydrous water glass or potassium-based anhydrous water glass exerts pinning effect, even if the surface of the carbon dioxide gas absorbent should be wetted, grain growth hardly occurs on the carbon dioxide gas absorbent. By incorporating alkali carbonate together with sodium silicate or potassium silicate, or sodium-based anhydrous water glass or potassium-based anhydrous water glass into the carbon dioxide gas absorbent, the carbon dioxide gas absorption characteristics of the carbon dioxide gas absorbent can be efficiently improved without allowing growth of the crystalline particles of the carbon dioxide gas absorbent.

The quantity of adding alkali carbonate with respect to the carbon dioxide gas absorbent is preferably 0.5 mol % or more but not more than about 40 mol %. In case the amount of added alkali carbonate should fall below 0.5 mol %, it is difficult to obtain the effect of improving the carbon dioxide gas absorption characteristics on the carbon dioxide gas absorbent. In case the amount of added alkali carbonate should exceed about 40 mol %, the effect of improving the carbon dioxide gas absorption characteristics of the carbon dioxide gas absorbent by adding alkali carbonate becomes saturated. Furthermore, since the content of lithium silicate in carbon dioxide gas absorbent decreases, the quantity of carbon dioxide gas absorption or the absorption rate of the carbon dioxide gas absorbent may drop. In particular, in case the amount of addition for the alkali carbonate is set to 0.5 mol % or higher but lower than about 5 mol %, the carbon dioxide gas absorption characteristics of the carbon dioxide gas absorbent become improved, and because the carbon dioxide gas absorbent undergoes less degradation, the carbon dioxide gas desorption characteristics also are improved. The above ranges include all values and subranges therebetween, including 0.75, 0.9, 1, 2, 3, 4, 5, 6, 7, 8, 9, 10, 12, 14, 16, 18, 20, 22, 24, 26, 28, 30, 31, 32, 33, 34, 35, 36, 37, 38 and 39 mol %.

When the carbon dioxide gas absorbent contains a large amount of sodium silicate or potassium silicate, or sodium-based anhydrous water glass or potassium-based anhydrous water glass, both alkali carbonate as well as sodium silicate or potassium silicate, or sodium-based anhydrous water glass or potassium-based anhydrous water glass increase the carbon dioxide gas absorption efficiency. When the sodium silicate or potassium silicate, or sodium-based anhydrous water glass or potassium-based anhydrous water glass is contained in large quantity, the content of lithium silicate in carbon dioxide gas absorbent can be increased while maintaining the high carbon dioxide gas absorption efficiency by decreasing the content of the alkali carbonate in the carbon dioxide gas absorbent. In case the carbon dioxide gas absorbent contains sodium silicate or potassium silicate, or sodium-based anhydrous water glass or potassium-based anhydrous water glass in large quantity, the concentration of alkali carbonate is preferably controlled as such to fall approximately in a range of from 0.5 mol % or higher but not higher than 10 mol %. This range includes all values and subranges therebetween, including 0.6, 0.7, 0.8, 0.9, 1, 2, 3, 4, 5, 6, 7, 8, and 9 mol %.

The carbon dioxide gas absorbent according to an embodiment of the invention may contain water (moisture). The exhaust gas and the like emitted from the combustion apparatus is high in temperature, however, there may be cases in which absorption of carbon dioxide gas low in temperature, for instance such at a room temperature, is required. Since the reactivity of the carbon dioxide gas absorbent according to the embodiment of the invention decreases at low temperatures, the carbon dioxide gas absorption characteristics of the carbon dioxide gas absorbent should be high. Since the reactivity of the carbon dioxide gas absorbent also decreases in case carbon dioxide gas low in concentration, such as that emitted by organisms or that contained in the atmosphere, is absorbed by the carbon dioxide gas absorbent, it is also necessary that the carbon dioxide gas absorption characteristics of the carbon dioxide gas absorbent are high.

In case carbon dioxide gas absorbent contains water, water accelerates the acid-base reaction between carbon dioxide gas and the lithium silicate contained in the carbon dioxide gas absorbent. Lithium carbonate is the reaction product of a carbon dioxide gas absorption reaction, and it covers the surface of lithium silicate. Water contained in carbon dioxide gas absorbent dissolves lithium carbonate to increase the carbon dioxide gas absorption characteristics of the carbon dioxide gas absorbent. When a large quantity of water is absorbed in a carbon dioxide gas absorbent, which does not contain any sodium silicate or potassium silicate, or sodium-based anhydrous water glass or potassium-based anhydrous water glass, water is incorporated into the pores of the carbon dioxide gas absorbent as to weaken the binding force among the fine particles constituting the carbon dioxide gas absorbent, and may cause clogging or cause a drop in strength of the carbon dioxide gas absorbent. Hence, a carbon dioxide gas absorbent that does not contain any sodium silicate or potassium silicate, or sodium-based anhydrous water glass or potassium-based anhydrous water glass cannot contain water in large quantity. The maximum amount of water absorbable by carbon dioxide gas absorbent not containing any sodium silicate or potassium silicate, or sodium-based anhydrous water glass or potassium-based anhydrous water glass was found to be about 8 wt %. This range includes all values and subranges therebetween, including 0.5, 1, 1.5, 2, 2.5, 3, 3.5, 4, 4.5, 5, 5.5, 6, 6.5, 7, and 7.5 wt %.

In the embodiment of the invention, the carbon dioxide gas absorbent contains sodium silicate or potassium silicate, or sodium-based anhydrous water glass or potassium-based anhydrous water glass. Water is stably held in sodium silicate or potassium silicate, or sodium-based anhydrous water glass or potassium-based anhydrous water glass in the form of absorbed water or crystal water. Otherwise, water is stably held in an aqueous solution containing sodium silicate or potassium silicate, or sodium-based anhydrous water glass or potassium-based anhydrous water glass. In these cases, the shape of the carbon dioxide gas absorbent is maintained.

By incorporating about 0.5 wt % of water in the carbon dioxide gas absorbent, the carbon dioxide gas absorption characteristics can be effectively improved. Moreover, conventionally, it was known to be difficult to incorporate about 8.5 wt % or more of water in the carbon dioxide gas absorbent. However, since sodium silicate or potassium silicate, or sodium-based anhydrous water glass or potassium-based anhydrous water glass is contained in the carbon dioxide gas absorbent according to the embodiment of the invention, water can be contained in the carbon dioxide gas absorbent at an amount of not only about 0.5 wt % or more, but also about 8.5 wt % or more. Water incorporated in the carbon dioxide gas absorbent at an amount exceeding about 25 wt % is not preferred because clogging occurs on the carbon dioxide gas absorbent. These ranges include all values and subranges therebetween, including 0.6, 0.7, 0.8, 0.9, 1, 2, 3, 4, 5, 6, 7, 8, 9, 10, 11, 12, 13, 14, 15, 16, 17, 18, 19, 20, 21, 22, 23 and 24 wt %.

As water to be incorporated in the carbon dioxide gas absorbent, usable is pure water or water containing dissolved therein a water-soluble alcohol such as ethanol. The carbon dioxide gas absorbent may be in a state as such that solid carbon dioxide gas absorbent contains water, or the carbon dioxide gas absorbent may be immersed in an aqueous medium.

In case solid carbon dioxide gas absorbent containing water is used, for instance, carbon dioxide gas absorbent in the form of powder, granules, or pellets, is placed inside a tubular carbon dioxide gas absorption apparatus. By allowing the gas to be treated to pass through the carbon dioxide gas absorption apparatus, the carbon dioxide gas absorbent absorbs the carbon dioxide gas.

In case particles of the carbon dioxide gas absorbent are dispersed in an aqueous medium to use it in the form of a suspension, by bubbling gas containing carbon dioxide gas to be treated into the carbon dioxide gas absorbent in the form of the aqueous medium suspension, carbon dioxide gas can be absorbed by the carbon dioxide gas absorbent.

In case of preparing a carbon dioxide gas absorbent heretofore, a binder was added to the raw materials and kneaded and/or mixed. As the binder, organic materials were mainly used. As the organic binder, there can be mentioned starch, methyl cellulose, polyvinyl alcohol, paraffin, and the like. An organic binder is lost in the subsequent step of heat treatment in the form of carbon dioxide gas and the like. When an organic binder is used, there have been found problems as such that there occurrs a drop in strength due to the formation of numerous pores after the heat treatment, and that the heat treatment step is not preferred from the environmental viewpoint because of the generation of carbon dioxide gas.

In the embodiment of the invention, sodium silicate or potassium silicate, or sodium-based anhydrous water glass or potassium-based anhydrous water glass is added after lithium carbonate is mixed with silicon dioxide. Sodium silicate or potassium silicate, or sodium-based anhydrous water glass or potassium-based anhydrous water glass functions as an inorganic binder. More specifically, in the method for manufacturing a carbon dioxide gas absorbent which includes a first mixing step for obtaining a first mixture by mixing lithium carbonate with silicon dioxide; a second mixing step for obtaining a second mixture by adding and mixing with the first mixture, an aqueous solution containing at least one selected from the group including sodium silicate and potassium silicate, or at least one selected from the group including sodium-based anhydrous water glass or potassium-based anhydrous water glass; a step of subjecting the second mixture to molding, granulating, or coating a substrate; and a heat treatment step of thermally treating the second mixture after the step of molding, granulating, or coating; the second mixing step corresponds to the step of adding the binder. In the embodiment of the invention, at least one type selected from the group including sodium silicate and potassium silicate, or at least one type selected from the group including sodium-based anhydrous water glass or potassium-based anhydrous water glass, is used as the binder. Combinations are possible.

In case at least one type selected from the group including sodium silicate and potassium silicate, or at least one type selected from the group including sodium-based anhydrous water glass or potassium-based anhydrous water glass, is used as a binder during the heat treatment in manufacturing the carbon dioxide gas absorbent, or during the absorption and desorption reaction of carbon dioxide gas at high temperatures, these are incorporated among the particles of the carbon dioxide gas absorbent and the particles of the raw materials as to suppress the grain growth based on the pinning effect.

In case anhydrous water glass (solid alkali silicate glass) is used as the binder, the binder is added in the form of an aqueous solution. In order to form an aqueous solution of the anhydrous water glass, the anhydrous water glass may be dissolved under high temperature and pressure, or the anhydrous water glass may be dissolved under ordinary temperature and pressure. After adding the aqueous solution of anhydrous water glass and applying heat treatment, water contained in the aqueous solution of anhydrous water glass evaporates to form anhydrous water glass.

Since at least one type selected from the group including sodium silicate and potassium silicate, or at least one type selected from the group including sodium-based anhydrous water glass or potassium-based anhydrous water glass is inorganic, it cannot be lost together during the heat treatment with the generation of carbon dioxide gas, but remains after the heat treatment step. Hence, it is effective for maintaining the shape and the strength of the carbon dioxide gas absorbent.

In the carbon dioxide gas absorbent, because at least one type selected from the group including sodium silicate and potassium silicate, or at least one type selected from the group including sodium-based anhydrous water glass or potassium-based anhydrous water glass functions as a material for improving the carbon dioxide gas absorption characteristics as well as the binder at the same time, there is no need of further adding a material that functions as a binder. Thus, it is preferred because the amount of carbon dioxide gas absorption per unit weight or unit volume of the carbon dioxide gas absorbent remains without being reduced.

The carbon dioxide gas absorbent according to an embodiment of the invention can sustain the shape and the strength by using sodium silicate or potassium silicate, or sodium-based anhydrous water glass or potassium-based anhydrous water glass. Hence it is suitable for producing carbon dioxide gas absorbents in the form of pellets, granules, or films. Combinations are possible.

In case of adding an aqueous solution containing at least one type selected from the group including sodium silicate or potassium silicate, or at least one type selected from the group including sodium-based anhydrous water glass or potassium-based anhydrous water glass into a mixture of lithium carbonate and silicon dioxide during the manufacturing process of the carbon dioxide gas absorbent, the concentration of at least one type selected from the group including sodium silicate or potassium silicate, or at least one type selected from the group including sodium-based anhydrous water glass or potassium-based anhydrous water glass is preferably set in a range of about 1 wt % or higher but not higher than about 60 wt %. This range includes all values and subranges therebetween, including 2, 3, 4, 5, 6, 7, 8, 9, 10, 12, 14, 16, 18, 20, 22, 24, 26, 28, 30, 32, 34, 36, 38, 40, 42, 44, 46, 48, 50, 51, 52, 53, 54, 55, 56, 57, 58 and 59 wt %. In case the concentration of at least one type selected from the group including sodium silicate or potassium silicate, or at least one type selected from the group including sodium-based anhydrous water glass or potassium-based anhydrous water glass is less than about 1 wt %, the water content of the carbon dioxide gas absorbent during its manufacturing process becomes high, and the carbon dioxide gas absorbent tends to generate warping and cracks on drying. In case the concentration exceeds about 60 wt %, the solute in the aqueous solution cannot precipitate, and it becomes difficult to obtain a homogeneous dispersion. The concentration of at least one type selected from the group including sodium silicate or potassium silicate, or at least one type selected from the group including sodium-based anhydrous water glass or potassium-based anhydrous water glass is more preferably, about 5 wt % or higher but not higher than about 40 wt %. This range includes all values and subranges therebetween, including 6, 7, 8, 9, 10, 12, 14, 16, 18, 20, 22, 24, 26, 28, 30, 31, 32, 33, 34, 35, 36, 37, 38 and 39 wt %.

<Manufacturing Method>

Some preferred examples for manufacturing carbon dioxide gas absorbents are shown below.

A method for manufacturing a pellet of carbon dioxide gas absorbent is described below. Lithium carbonate and silicon dioxide each weighed at predetermined amounts are mixed in an agate mortar and the like for time duration of about 0.1 to 1 hour. This range includes all values and subranges therebetween, including 0.2, 0.3, 0.4, 0.5, 0.6, 0.7, 0.8 and 0.1 hrs. An aqueous solution containing at least one type selected from the group including sodium silicate or potassium silicate, or at least one type selected from the group including sodium-based anhydrous water glass or potassium-based anhydrous water glass is added into the thus obtained mixed powder. After kneading the aqueous solution added to the mixed powder, a cylindrical pellet is obtained by molding the mixture with an extruder. The cylindrical pellet is heat treated in a box-type furnace and the like under the atmosphere for about 0.5 to 20 hours to obtain a carbon dioxide gas absorbent of lithium silicate pellet. This range includes all values and subranges therebetween, including 0.7, 0.9, 1, 3, 5, 7, 9, 11, 13, 15, 17 and 19 hrs. The carbon dioxide gas absorbent uniformly contains at least one type selected from the group including sodium silicate or potassium silicate, or at least one type selected from the group including sodium-based anhydrous water glass or potassium-based anhydrous water glass. The porosity of the carbon dioxide gas absorbent thus obtained is preferably in a range of from about 30 to about 50 vol %. This range includes all values and subranges therebetween, including 31, 33, 35, 37, 39, 41, 43, 45, 47 and 49 vol %. Binder remains in this manufacturing method because inorganic sodium silicate or potassium silicate, or sodium-based anhydrous water glass or potassium-based anhydrous water glass is used as the binder. The carbon dioxide gas absorbent containing remaining therein the binder maintains strength capable of holding the shape even if it is porous.

A method for manufacturing a powder of carbon dioxide gas absorbent is described below. The manufacturing method for a pellet of carbon dioxide gas absorbent described above is followed, except for not making an aqueous solution, but adding at least one type selected from the group including sodium silicate or potassium silicate, or at least one type selected from the group including sodium-based anhydrous water glass or potassium-based anhydrous water glass directly to the mixed powder, and for applying the heat treatment without molding the mixed powder.

A method for manufacturing granules of carbon dioxide gas absorbent is described below. Lithium carbonate and silicon dioxide each weighed at predetermined amounts are wet-mixed by using water as the dispersion medium. In case lithium orthosilicate is used as the lithium silicate, the mixing ratio of lithium carbonate and silicon dioxide (Li₂CO₃:SiO₂) in molar ratio is preferably 2:1. After adding and kneading an aqueous solution containing at least one type selected from sodium silicate or potassium silicate, or at least one type selected from sodium-based anhydrous water glass or potassium-based anhydrous water glass, the mixture is granulated to obtain granules. As a granulation method, there can be employed methods, such as spray drying, fluidized bed granulating, pressure swinging, extruding, and the like. The time necessary for the granulation depends on what kind of granulation machines is used. Preferably, granulation is performed until granules about 100 to 2000 μm in particle diameter are obtained. This range includes all values and subranges therebetween, including 125, 150, 175, 200, 300, 400, 500, 600, 700, 800, 900, 1000, 1300, 1500, 1700, and 1900 μm. In case the particle diameter is less than about 100 μm, there is fear of causing clogging in case carbon dioxide gas is flown into an apparatus packed with the granules of carbon dioxide gas absorbent. On the other hand, in case the particle diameter is larger than about 2000 μm, it becomes difficult for carbon dioxide gas to intrude inside the carbon dioxide gas absorbent. Drying may be performed simultaneously with granulation. The temperature of drying is preferably about 100° C. or lower, at which water can be volatilized. This range includes all values and subranges therebetween, including 25, 30, 40, 50, 60, 70, 80, and 90° C. After drying, the granules are heat treated in a box-type furnace in a temperature range of from about 600 to 1200° C. to obtain granules of carbon dioxide gas absorbent.

A method for manufacturing a film of carbon dioxide gas absorbent is described below. Lithium carbonate and silicon dioxide each weighed at predetermined amounts are wet-mixed by using water as the dispersion medium. An aqueous solution containing at least one type selected from the group including sodium silicate or potassium silicate, or at least one type selected from the group including sodium-based anhydrous water glass or potassium-based anhydrous water glass is added into the thus prepared mixture to obtain slurry. The resulting slurry is applied onto a substrate made of alumina and the like, and dried. In case of coating the slurry, the film thickness of the slurry is set in a range of from about 5 μm to 1 cm. This range includes all values and subranges therebetween, including 10, 20, 40, 50, 100, 200, 300, 500, 700, and 900 μm, and 0.1, 0.2, 0.3, 0.4, 0.5, 0.6, 0.7, 0.8, and 0.9 cm. After drying, film-like carbon dioxide gas absorbent can be obtained by applying heat treatment in the temperature range of from about 600 to 1200° C. This range includes all values and subranges therebetween, including 625, 650, 675, 700, 800, 900, 1000, 1100, 1125, 1150, and 1175° C. The film-like carbon dioxide gas absorbent preferably has a porosity of about 30% or higher but not higher than about 60%. This range includes all values and subranges therebetween, including 31, 33, 35, 37, 39, 40, 41, 43, 45, 47, 49, 51, 53, 55, 57, and 59%. In case the porosity is lower than about 30%, it becomes difficult for carbon dioxide gas to intrude inside the carbon dioxide gas absorbent, and the carbon dioxide gas absorption characteristics of the film decrease. On the other hand, in case the porosity becomes higher than about 60%, not only the mechanical strength of the film-like carbon dioxide gas absorbent, but also the amount of absorbable carbon dioxide gas decreases.

The method of manufacturing carbon dioxide gas absorbent is not limited to the method mentioned above. For instance, the following methods may be used. This manufacturing method for a carbon dioxide gas absorbent described above is followed, except for not adding at least one type selected from the group including sodium silicate or potassium silicate, or at least one type selected from the group including sodium-based anhydrous water glass or potassium-based anhydrous water glass directly to the mixed powder of lithium carbonate and silicon dioxide, but heating the mixed powder of lithium carbonate and silicon dioxide. After heating, at least one type selected from the group including sodium silicate or potassium silicate, or at least one type selected from the group including sodium-based anhydrous water glass or potassium-based anhydrous water glass is added to the mixed powder of lithium carbonate and silicon dioxide, and then, the mixed powder is molded, granulated, or coated. When carbon dioxide gas absorbent is made by this method, binder remains. And the carbon dioxide gas absorbent that has sufficient strength to maintain form can be obtained. This method for a carbon dioxide gas absorbent is applicable to the pellets, the powder, the granules, and the film of carbon dioxide gas absorbent.

The method of incorporating water into the carbon dioxide gas absorbent is described below. After preparing the carbon dioxide gas absorbents according to above each specific process, for instance, the carbon dioxide gas absorbent may be allowed to stand in gaseous nitrogen atmosphere containing water vapor but substantially free of carbon dioxide gas. In this case, the concentration of water vapor is preferably set at 1.1 times the saturation water vapor concentration or lower at the temperature. This range includes all values and subranges therebetween, including 1, 0.9, 0.8, 0.7, 0.6, 0.5, 0.4, 0.3, 0.2 and 0.1 times. If water vapor concentration is too high, water adheres on the surface of the carbon dioxide gas absorbent to form water droplets, and it is feared that water locally occurs on the surface of the carbon dioxide gas absorbent. The water content of the carbon dioxide gas absorbent can be controlled in this manner. Gaseous nitrogen above may be replaced by other inert gases such as argon, so long as no carbon dioxide gas is contained therein.

Another method for incorporating water into the carbon dioxide gas absorbent is described below.

After mixing lithium carbonate and silicon dioxide, the mixture is subjected to heat treatment without adding any of at least one type selected from the group including sodium silicate or potassium silicate, or at least one type selected from the group including sodium-based anhydrous water glass or potassium-based anhydrous water glass, or an aqueous solution thereof, and without performing molding, granulating, or coating. By adding at least one type selected from the group including sodium silicate or potassium silicate, or at least one type selected from the group including sodium-based anhydrous water glass or potassium-based anhydrous water glass thereafter, a powder of the carbon dioxide gas absorbent is obtained.

After mixing lithium carbonate and silicon dioxide, the mixture is subjected to heat treatment without adding any of at least one type selected from the group including sodium silicate or potassium silicate, or at least one type selected from the group including sodium-based anhydrous water glass or potassium-based anhydrous water glass, or an aqueous solution thereof, and without performing molding, granulating, or coating. After that an aqueous solution of at least one type selected from the group including sodium silicate or potassium silicate, or at least one type selected from the group including sodium-based anhydrous water glass or potassium-based anhydrous water glass is added. Thus, a pellet of carbon dioxide gas absorbent can be obtained by molding, granules of carbon dioxide gas absorbent can be obtained by granulation, and film-like carbon dioxide gas absorbent can be obtained by coating it on a substrate.

After preparing the carbon dioxide gas absorbent each in the form of a powder, a pellet, granules, or a film, water is allowed to remain therein by applying incomplete drying. Otherwise, the resulting product is placed inside an atmosphere containing water vapor and is added water to the product. In this method, carbon dioxide gas absorbents each containing water can be easily obtained. Thus, according to this method, absorbents having high density can be obtained because molding, granulating, or coating is performed after generating carbon dioxide gas in the heat treatment step.

<Method of Usage, Regenerating Method>

The carbon dioxide gas absorbent can be regenerated by desorbing the carbon dioxide gas once absorbed by the carbon dioxide gas absorbent. Thus regenerated carbon dioxide gas absorbent can be subjected to reuse. In case of allowing the carbon dioxide gas absorbent to desorb the absorbed carbon dioxide gas, heat treatment is applied in the temperature range of from 350 to 1000° C., but heating to such a high temperature causes volatilization of water. This range includes all values and subranges therebetween, including 400, 500, 600, 700, 800, 900 and 950° C. In case carbon dioxide gas absorbent containing no water absorbs carbon dioxide gas under the room temperature, the carbon dioxide gas absorption characteristics result low. Thus, it is found necessary to incorporate water again into the carbon dioxide gas absorbent.

An example of incorporating water into the carbon dioxide gas absorbent is described below. The carbon dioxide gas absorbent once heated is cooled under an atmosphere free of carbon dioxide gas. After cooling, the carbon dioxide gas absorbent is exposed to an atmosphere containing water vapor but free of carbon dioxide gas for humidification.

In case of regenerating the carbon dioxide gas absorbent, by the reason similar to the above, water incorporated in the carbon dioxide gas absorbent is set, preferably, to at least 0.5 wt % or higher, and particularly preferably, to 8.5 wt % or higher. This range includes all values and subranges therebetween, including 0.6, 0.7, 0.8, 0.9, 1, 2, 3, 4, 5, 6, 7, 8, 8.1, 8.2, 8.3, and 8.4 wt %.

### EXAMPLES

Having generally described this invention, a further understanding can be obtained by reference to certain specific examples which are provided herein for purposes of illustration only and are not intended to be limiting unless otherwise specified.

### Example 1

Lithium carbonate powder consisting of particles 1 μm in average particle diameter and silicon dioxide powder consisting of particles 0.8 μm in average particle diameter were each weighed and mixed at a molar ratio of 2:1, and the resulting mixture was dry mixed in an agate mortar for 10 minutes. To 100 g (gram) of the mixed powder, 60 g of 10 wt % aqueous solution of potassium silicate (K₂Si₂O₃) was added, and the resulting product was kneaded for 10 minutes. The kneaded product was extruded under an applied pressure of 30 kgf/cm² by using an extruder to obtain a pellet. The pellet was heat treated under the atmosphere at 1000° C. for 8 hours to obtain a carbon dioxide gas absorbent in the form of a potassium silicate-added lithium silicate pellet.

### Example 2

The same procedure as that described in Example 1 was followed to obtain a pellet, except for changing the addition of the aqueous solution of potassium silicate to 10 g.

### Example 3

The same procedure as that described in Example 1 was followed to obtain a pellet, except for changing the addition of the aqueous solution of potassium silicate to 200 g.

### Example 4

The same procedure as that described in Example 1 was followed to obtain a pellet, except for changing the addition of the aqueous solution of potassium silicate to 300 g.

### Example 5

The same procedure as that described in Example 1 was followed to obtain a pellet, except for changing the addition of the aqueous solution of potassium silicate to 400 g.

### Example 6

The same procedure as that described in Example 1 was followed to obtain a pellet, except for changing the addition of the aqueous solution of potassium silicate to 60-g addition of 10% aqueous solution of sodium silicate.

### Example 7

Lithium carbonate powder consisting of particles 1 μm in average particle diameter and silicon dioxide powder consisting of particles 0.8 μm in average particle diameter were each weighed and mixed at a molar ratio of 2:1, and the resulting mixture was dry mixed in an agate mortar for 10 minutes. To 100 g of the mixed powder, 60 g of 10% aqueous solution of potassium silicate (K₂Si₂O₅) was added, and granules 500 μm in average particle diameter were obtained by fluidized bed granulating method. The resulting granules were heat treated under the atmosphere at 1000° C. for 8 hours to obtain a carbon dioxide gas absorbent in the form of potassium silicate-added lithium silicate granules.

### Example 8

The same procedure as that described in Example 7 was followed to obtain granules, except for changing the addition of the aqueous solution of potassium silicate to 10 g.

### Example 9

The same procedure as that described in Example 7 was followed to obtain granules, except for changing the addition of the aqueous solution of potassium silicate to 200 g.

### Example 10

Lithium carbonate powder consisting of particles 1 μm in average particle diameter and silicon dioxide powder consisting of particles 0.8 μm in average particle diameter were each weighed and mixed at a molar ratio of 2:1, and the resulting mixture was dry mixed in an agate mortar for 10 minutes. To 100 g of the mixed powder, 200 g of 10% aqueous solution of potassium silicate (K₂Si₂O₅) was added to prepare slurry. The resulting slurry was fed inside an applicator having a gap of 1 mm, and a coated film was obtained by in-plane moving an alumina substrate. The film thus obtained was subjected to heat treatment under the atmosphere at 1000° C. for 8 hours to obtain a carbon dioxide gas absorbent in the form of a potassium silicate-added lithium silicate film.

### Example 11

The same procedure as that described in Example 10 was followed to obtain a film, except for changing the addition of the aqueous solution of potassium silicate to 60 g.

### Example 12

The same procedure as that described in Example 10 was followed to obtain a film, except for changing the addition of the aqueous solution of potassium silicate to 300 g.

### Example 13

Lithium carbonate powder consisting of particles 1 μm in average particle diameter and silicon dioxide powder consisting of particles 0.8 μm in average particle diameter were each weighed and mixed at a molar ratio of 2:1, and the resulting mixture was dry mixed in an agate mortar for 10 minutes. To 100 g of the mixed powder, 6 g of potassium silicate (K₂Si₂O₅) was added and mixed for 10 minutes. After mixing, the product was subjected to heat treatment under the atmosphere at 1000° C. for 8 hours to obtain a carbon dioxide gas absorbent in the form of a potassium silicate-added lithium silicate powder.

### Example 14

The same procedure as that described in Example 1 was followed to obtain a pellet, except for changing the addition of the aqueous solution of potassium silicate to 500 g.

### Example 15

The same procedure as that described in Example 7 was followed to obtain granules, except for changing the addition of the aqueous solution of potassium silicate to 500 g.

### Example 16

The same procedure as that described in Example 10 was followed to obtain a film, except for changing the addition of the aqueous solution of potassium silicate to 500 g.

### Example 17

Lithium carbonate powder consisting of particles 1 μm in average particle diameter and silicon dioxide powder consisting of particles 0.8 μm in average particle diameter were each weighed and mixed at a molar ratio of 2:1, and the resulting mixture was dry mixed in an agate mortar for 10 minutes. To 100 g of the mixed powder, 45 g of 20% aqueous solution of potassium-based anhydrous water glass (K₂O-4SiO₂) was added and kneaded for 10 minutes. After kneading, the kneaded product was extruded under an applied pressure of 30 kgf/cm² by using an extruder to obtain a pellet. The pellet was heat treated under the atmosphere at 1000° C. for 8 hours to obtain a carbon dioxide gas absorbent in the form of a lithium silicate pellet having added therein potassium-based anhydrous water glass.

### Example 18

The same procedure as that described in Example 17 was followed to obtain a pellet, except for changing the addition of the aqueous solution of potassium-based anhydrous water glass to 6 g.

### Example 19

The same procedure as that described in Example 17 was followed to obtain a pellet, except for changing the addition of the aqueous solution of potassium-based anhydrous water glass_to 160 g.

### Example 20

The same procedure as that described in Example 17 was followed to obtain a pellet, except for changing the addition of the aqueous solution of potassium-based anhydrous water glass to 240 g.

### Example 21

The same procedure as that described in Example 17 was followed to obtain a pellet, except for changing the addition of the aqueous solution of potassium-based anhydrous water glass to 300 g.

### Example 22

The same procedure as that described in Example 17 was followed to obtain a pellet, except for using 45 g of a 20% aqueous solution of sodium-based anhydrous water glass (Na₂O-4SiO₂) in place of the aqueous solution of potassium-based anhydrous water glass.

### Example 23

Lithium carbonate powder consisting of particles 1 μm in average particle diameter and silicon dioxide powder consisting of particles 0.8 μm in average particle diameter were each weighed and mixed at a molar ratio of 2:1, and the resulting mixture was dry mixed in an agate mortar for 10 minutes. To 100 g of the mixed powder, 45 g of 20% aqueous solution of potassium-based anhydrous water glass (K₂O-4SiO₂) was added, and granules 500 μm in average particle diameter were obtained by fluidized bed granulating method. The resulting granules were heat treated under the atmosphere at 1000° C. for 8 hours to obtain a carbon dioxide gas absorbent in the form of lithium silicate granules_having added therein potassium-based anhydrous water glass.

### Example 24

The same procedure as that described in Example 23 was followed to obtain granules, except for changing the addition of the aqueous solution of potassium-based anhydrous water glass to 6 g.

### Example 25

The same procedure as that described in Example 23 was followed to obtain granules, except for changing the addition of the aqueous solution of potassium-based anhydrous water glass to 160 g.

### Example 26

Lithium carbonate powder consisting of particles 1 μm in average particle diameter and silicon dioxide powder consisting of particles 0.8 μm in average particle diameter were each weighed and mixed at a molar ratio of 2:1, and the resulting mixture was dry mixed in an agate mortar for 10 minutes. To 100 g of the mixed powder, 160 g of 20% aqueous solution of potassium-based anhydrous water glass (K₂O-4SiO₂) was added to prepare slurry. The resulting slurry was fed inside an applicator having a gap of 1 mm, and a coated film was obtained by in-plane moving on an alumina substrate. The film thus obtained was subjected to heat treatment under the atmosphere at 1000° C. for 8 hours to obtain a carbon dioxide gas absorbent in the form of a lithium silicate film having added therein potassium-based anhydrous water glass.

### Example 27

The same procedure as that described in Example 26 was followed to obtain a film, except for changing the addition of the aqueous solution of potassium-based anhydrous water glass to 45 g.

### Example 28

The same procedure as that described in Example 26 was followed to obtain a film, except for changing the addition of the aqueous solution of potassium-based anhydrous water glass to 240 g.

### Example 29

Lithium carbonate powder consisting of particles 1 μm in average particle diameter and silicon dioxide powder consisting of particles 0.8 μm in average particle diameter were each weighed and mixed at a molar ratio of 2:1, and the resulting mixture was dry mixed in an agate mortar for 10 minutes. To 100 g of the mixed powder, 9 g of potassium-based anhydrous water glass was added and mixed for 10 minutes. After mixing, the product was subjected to heat treatment under the atmosphere at 1000° C. for 8 hours to obtain a carbon dioxide gas absorbent in the form of a lithium silicate powder having added therein potassium-based anhydrous water glass.

### Example 30

The same procedure as that described in Example 17 was followed to obtain a pellet, except for changing the addition of the aqueous solution of potassium-based anhydrous water glass to 400 g.

### Example 31

The same procedure as that described in Example 23 was followed to obtain granules, except for changing the addition of the aqueous solution of potassium-based anhydrous water glass_to 400 g.

### Example 32

The same procedure as that described in Example 26 was followed to obtain a film, except for changing the addition of the aqueous solution of potassium-based anhydrous water glass to 400 g.

### Comparative Example 1

A pellet was prepared by following the method described in Example 1, except for not adding an aqueous solution of potassium silicate.

The carbon dioxide gas absorbents thus obtained in Examples 1 to 32 and in Comparative Example 1 were set inside a box-type furnace, and were allowed to absorb carbon dioxide gas by holding the temperature at 500° C. for 1 hour while flowing mixed gas containing 20% by volume (vol %) of carbon dioxide gas and 80 vol % of gaseous nitrogen inside the furnace. The absorbed amount of carbon dioxide gas was obtained to measure the mass gain of the carbon dioxide gas absorbents. The power output of the furnace was fixed to maintain 500° C. even in case the temperature inside the furnace should be elevated while carbon dioxide gas absorption proceeded on the carbon dioxide gas absorbent. Accordingly, in some instances, the temperature of the carbon dioxide gas absorbent may be 500° C. or higher. The results obtained on the absorbed amount of carbon dioxide gas are given as initial amount of absorption in Tables 1 and 2.

Similar experiment was conducted by supplying gaseous nitrogen alone to the furnace in which the carbon dioxide gas absorbents obtained in each of the Examples and Comparative Example are set. In case gaseous nitrogen alone is supplied, it was confirmed that no mass gain was observed on the carbon dioxide gas absorbents.

Then, the carbon dioxide gas absorbents obtained in Examples 1 to 32 and in Comparative Example 1 were set inside the furnace above, where they were allowed to absorb carbon dioxide gas by holding the temperature at 500° C. for 1 hour while flowing mixed gas containing 20% by volume (vol %) of carbon dioxide gas and 80 vol % of gaseous nitrogen inside the furnace and were then allowed to desorb carbon dioxide gas by holding the temperature at 800° C. for 1 hour. These operations were repeated 100 times. After 100-time repetition, they were maintained at a temperature 500° C. for 1 hour to allow the carbon dioxide gas absorbents to absorb carbon dioxide gas. Subsequently, they were cooled to room temperature to observe mass gain. The ratio of the amount of absorption after repeating absorption and desorption for 100 times to the initial amount of absorption is denoted as absorption maintenance ratio, and is given in Tables 1 and 2.

Tables 1 and 2 read that high values are obtained in Examples 1 to 32 for the initial amount of absorption and the absorption maintenance ratio. The results are ascribed to the fact that the carbon dioxide gas absorbents of Examples 1 to 32 contain at least one type selected from sodium silicate and potassium silicate, or at least one type selected from sodium-based anhydrous water glass and potassium-based anhydrous water glass in addition to lithium silicate. In Comparative Example 1, the carbon dioxide gas absorption maintenance ratio is lowered. This is believed attributed to the grain growth occurring on the carbon dioxide gas absorbent. Grain growth occurs because there is no addition of at least one type selected from sodium silicate and potassium silicate, or at least one type selected from sodium-based anhydrous water glass and potassium-based anhydrous water glass.

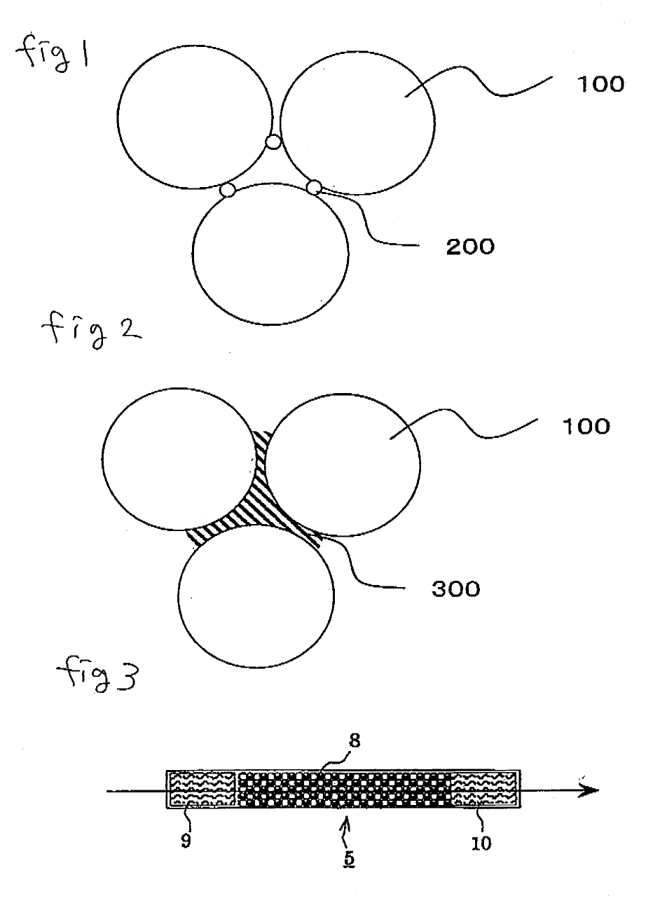

The surface of the carbon dioxide gas absorbents obtained in Examples 1 and 17 was investigated. The surface of the carbon dioxide gas absorbent obtained in Example 1 was found to be in a state shown in FIG. 1. Referring to FIG. 1, particles of potassium silicate 200 were found to be dispersed among the particles of lithium silicate 100. The surface of the carbon dioxide gas absorbent obtained in Example 17 was found to be in a state shown in FIG. 2. Referring to FIG. 2, film-like potassium-based anhydrous water glass 300 was found to be dispersed among the particles of lithium silicate 100. In the carbon dioxide gas absorbents obtained in both Examples, pinning effect was obtained by potassium silicate and film-like potassium-based anhydrous water glass, and hardly any grain growth took place. In the carbon dioxide gas absorbent obtained in Example 17, a part of potassium-based anhydrous water glass was found to be crystallized to give potassium silicate.

As read from Tables 1 and 2, more preferably in the Examples, at least one type selected from sodium silicate and potassium silicate, or at least one type selected from sodium-based anhydrous water glass and potassium-based anhydrous water glass is added in the carbon dioxide gas absorbents at an amount of about 5 mol % or more but not more than about 30 mol %. By thus setting the addition to 5 mol % or higher, the absorption maintenance ratio increases, while the initial amount of absorption increases by setting the addition to 30 mol % or lower.

As read from Tables 1 and 2, in the Examples, in case at least one type selected from sodium silicate and potassium silicate is added into the carbon dioxide gas absorbent, the absorption maintenance ratio increases as compared with the case in which at least one type selected from sodium-based anhydrous water glass and potassium-based anhydrous water glass is added. At least one type selected from sodium-based anhydrous water glass and potassium-based anhydrous water glass is dispersed in the carbon dioxide gas absorbent in the form of a film. Since at least one type selected from sodium silicate and potassium silicate is dispersed in the form of particles, more uniform dispersion can be achieved in this case. Since at least one type selected from sodium silicate and potassium silicate is dispersed more uniformly in the carbon dioxide gas absorbent, it can provide pinning effect to larger number of particles of the carbon dioxide gas absorbent. Furthermore, because the pinning effect is high, i.e., the effect of maintaining the shape is high, it is presumed that a higher absorption maintenance ratio is achieved.

As read from Tables 1 and 2, the addition of potassium silicate or potassium-based anhydrous water glass is preferred, because their addition increases the initial amount of absorption as compared to the case of adding sodium silicate or sodium-based anhydrous water glass.

The carbon dioxide gas absorption characteristics at room temperature are explained below by making reference to Examples 33 to 38 and Comparative Examples 2 to 4.

### Example 33

Lithium carbonate powder consisting of particles 1 μm in average particle diameter and silicon dioxide powder consisting of particles 0.8 μm in average particle diameter were each weighed and mixed at a molar ratio of 2:1, and the resulting mixture was dry mixed in an agate mortar for 10 minutes. After mixing, the mixed powder was subjected to heat treatment under the atmosphere at 1000° C. for 8 hours to obtain lithium silicate. After size reducing the resulting lithium silicate to particles having an average particle diameter of 2 μm, 120 g of 9% aqueous solution of potassium silicate (K₂Si₃O₇) was added to 200 g of the resulting lithium silicate, and granulation was performed in an extruder to obtain granules having an average particle size of 500 μm. Subsequently, the product thus obtained was dried in furnace at 80° C. for 60 minutes to obtain lithium silicate granules.

### Example 34

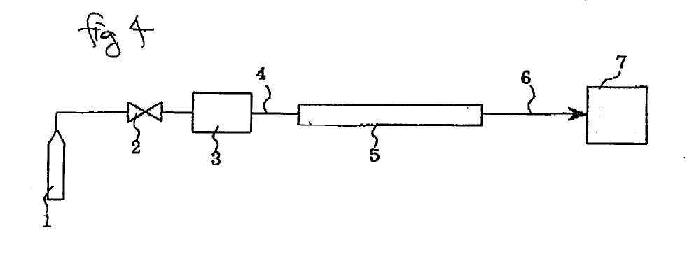

After preparing granules in the same manner as in Example 33, the resulting granules 8 were set between filters 7, 9 of the absorption tube 5 shown in FIG. 3. Gas containing water vapor and nitrogen at a ratio of 3.5 to 96.5 (vol %) was flown inside the absorption tube 5 charged with the granules 8 at a rate of 1.0 L/min for 5 hours to obtain lithium silicate granules.

### Example 35

After preparing granules in the same manner as in Example 33, the resulting granules were dried in furnace at 100° C. for 60 minutes to obtain lithium silicate granules.

### Example 36

The carbon dioxide gas absorbent manufactured in Example 33 was charged inside the carbon dioxide gas absorption tube shown in FIG. 3, and nitrogen gas containing 500 ppm of carbon dioxide gas having mixed therein 1 vol % of water vapor was flown inside the absorption tube at room temperature at a flow rate of 1 L/min to allow the carbon dioxide gas absorbent to absorb carbon dioxide gas. The carbon dioxide gas absorbent was found to absorb carbon dioxide gas at an amount corresponding to 16 wt % of the carbon dioxide gas absorbent. Then, heating at 480° C. for 5 hours under a nitrogen gas flowing atmosphere was performed to allow the carbon dioxide gas absorbent to desorb carbon dioxide gas. The mass of the carbon dioxide gas absorbent cooled in gaseous nitrogen atmosphere was measured to find that it was approximately equal to that prepared in the same manner as in Example 33. Thus, the absorbed carbon dioxide gas and water were confirmed to be entirely discharged. Then, the carbon dioxide gas absorbent was fed inside the absorption tube 5, and a gas containing water vapor and nitrogen at a ratio of 3.5 to 96.5 (vol %) was flown inside the absorption tube 5 at a rate of 1.0 L/min for 5 hours to obtain lithium silicate granules denoted as Example 36.

### Example 37

After preparing granules in the same manner as in Example 33, the resulting granules were dried in furnace at 250° C. for 60 minutes to obtain lithium silicate granules.

### Example 38

Lithium carbonate powder consisting of particles 1 μm in average particle diameter and silicon dioxide powder consisting of particles 0.8 μm in average particle diameter were each weighed and mixed at a molar ratio of 2:1, and the resulting mixture was dry mixed in an agate mortar for 10 minutes. After mixing, the mixed powder was subjected to heat treatment under the atmosphere at 1000° C. for 8 hours to obtain lithium silicate. After size reducing the resulting lithium silicate to particles having an average particle diameter of 2 μm, 20 g of 25 wt % aqueous solution of potassium-based anhydrous water glass (K₂O-3SiO₂) and 100 g of pure water were added to 200 g of the resulting lithium silicate, and granulation was performed in an extruder to obtain granules having an average particle size of 500 μm. Subsequently, the product thus obtained was dried in furnace at 250° C. for 60 minutes to obtain lithium silicate granules. (Comparative Example 2) After preparing granules in the same manner as in Example 33, the resulting granules were dried in furnace at 60° C. for 20 minutes to obtain lithium silicate granules.

### Comparative Example 3

After preparing granules in the same manner as in Example 33, the resulting granules were dried in furnace at 400° C. for 300 minutes to obtain lithium silicate granules.

### Comparative Example 4

After size reducing the lithium silicate prepared in the same manner as in Example 33 to particles having an average particle diameter of 2 μm, the lithium silicate was weighed and kneaded with sepiolite powder at a weight ratio of 9:1. To 100 g of the resulting kneaded product, 25 g of water was further added therein and additional mixing was applied thereto. After mixing, granulation of the mixture was performed in an extruder to obtain granules having an average particle diameter of 500 μm, and the resulting granules were dried in furnace at 100° C. for 24 hours. Furthermore, heat treatment was performed under the atmosphere at 500° C. for 2 hours. Subsequently, the resulting granules 8 were set between filters 7, 9 of the absorption tube 5 shown in FIG. 3. Gas containing water vapor and nitrogen at a ratio of 3.5 to 96.5 (vol %) was flown inside the absorption tube 5 charged with the granules 8 at a rate of 1.0 L/min for 20 hours to obtain lithium silicate granules.

The water content of the carbon dioxide gas absorbents obtained in Examples 33 to 38 and in Comparative Examples 2 to 4 was measured with thermogravimetric analyzer (TG). Concerning the measuring method, the carbon dioxide gas absorbents were placed inside the analyzer, and temperature was elevated from room temperature (25° C.) to 300° C. at a rate of 5° C./min while flowing gaseous nitrogen under a pressure of 1 atm and at a rate of 300 ml/min, and then the temperature was held at 300° C. for 2 hours. In this manner, water contained in the carbon dioxide gas absorbent was allowed to discharge, and the mass loss attributed to the emission was investigated. By this measurement, the water content in each of the carbon dioxide gas absorbents prepared in Examples and Comparative Examples was obtained. The results are shown in Table 3.

The carbon dioxide gas absorption characteristics of the carbon dioxide gas absorbents obtained in the Examples and Comparative Examples were evaluated by using a carbon dioxide gas absorption evaluation apparatus shown in FIG. 4.

The flow rate of the gas containing carbon dioxide gas (nitrogen gas containing 500 ppm of carbon dioxide gas) led out from carbon dioxide gas bomb 1 is controlled by a flow mass controller valve 2. Water vapor is added at an amount of 2 vol % to the resulting gas by using a water vapor addition unit 3 to obtain a gas in a state similar to that present in the room. The resulting gas is the inlet gas 4. The inlet gas 4 is then discharged as an outlet gas 6 after carbon dioxide gas is absorbed by the carbon dioxide gas absorption tube 5. The flow rate of the inlet gas 4 is controlled as such that the flow rate may be 1L/min under atmospheric pressure. The carbon dioxide gas concentration of the outlet gas 6 is measured with a carbon dioxide gas concentration meter 7. As shown in FIG. 3, the carbon dioxide gas absorption tube 5 is a Teflon tube 10 mm in inner diameter. The carbon dioxide gas absorbent 8 is packed in the carbon dioxide gas absorption tube 5 to a length of 70 mm. Absorbent cotton 9, 10 is fitted as filter members to the both ends of the carbon dioxide gas absorbent. The filter 9 on the gas inlet side is used for uniformly dispersing the inlet gas 4, and the filter 10 on the gas outlet side prevents mixing and diffusion of carbon dioxide gas absorbent into the outlet gas 6.

The carbon dioxide gas absorbents obtained in Examples 33 to 38 and in Comparative Examples 2 to 4 were set inside the carbon dioxide gas absorption evaluation apparatus above. The carbon dioxide gas absorbents were allowed to absorb carbon dioxide gas by flowing gas containing carbon dioxide gas inside the evaluation apparatus at room temperature (25° C.) for 20 hours. Changes of the carbon dioxide gas concentration on the outlet of the absorption tube was measured as a function of time, and the amount of absorbed carbon dioxide gas for each of the carbon dioxide gas absorbents was calculated based on the measured results. The results (absorption amount of carbon dioxide gas) are given in Table 3.

Experiments were performed in a manner similar to the measurements above by flowing gaseous nitrogen alone inside the carbon dioxide gas absorption evaluation apparatus of each Example and Comparative Example in which the carbon dioxide gas absorbents are set. In case gaseous nitrogen alone was flown, it was confirmed that no mass gain occurred.

Table 3 reads that the amount of carbon dioxide gas absorption of the carbon dioxide gas absorbents for Examples 33 to 38 shows high values exceeding 10 wt % even under the condition of low reactivity, i.e., at room temperature. The results are attributed to the fact that the carbon dioxide gas absorbents of Examples 33 to 38 contain at least one type selected from sodium silicate and potassium silicate, or at least one type selected from sodium-based anhydrous water glass and potassium-based anhydrous water glass, and that they contain water at a concentration of 0.5 wt % or higher.

In Comparative Example 3, the amount of carbon dioxide gas absorption of the carbon dioxide gas absorbent under the condition of low reactivity, i.e., at room temperature, is lower than 10 wt %. This is because, although the carbon dioxide gas absorbent of Comparative Example 3 contains potassium silicate, the water concentration is as low as 0.4 wt %.

In Comparative Example 2, the amount of carbon dioxide gas absorption of the carbon dioxide gas absorbent is lower than 10 wt % because clogging and the like occurred. The carbon dioxide gas absorbent of Comparative Example 2 contains potassium silicate, but the water concentration is too high as 28 wt %.

In Comparative Example 4, the water content was set exceeding 8 wt %. In such a case, clogging and the like occurred to impair the absorption of the carbon dioxide gas absorbent to be lower than 10 wt %. This is attributed to the fact that the carbon dioxide gas absorbent of Comparative Example 4 contains none of at least one type selected from sodium silicate and potassium silicate, or at least one type selected from sodium-based anhydrous water glass and potassium-based anhydrous water glass.

Higher carbon dioxide gas absorption characteristics are achieved in each of the Examples containing at least one type selected from sodium silicate and potassium silicate, or at least one type selected from sodium-based anhydrous water glass and potassium-based anhydrous water glass, and in which the water concentration is set in a range of 0.5 wt % or higher but not higher than 25 wt %. In view of Example 36, the carbon dioxide gas absorbent is sufficiently regenerated even under conditions of low reactivity, i.e., at room temperature.

Effects similar to those obtained in the Examples are also available by further adding alkali carbonates and the like to the carbon dioxide gas absorbents in which at least one type selected from sodium silicate and potassium silicate, or at least one type selected from sodium-based anhydrous water glass and potassium-based anhydrous water glass is added.

As described in detail above in the embodiment of the invention, there are provided carbon dioxide gas absorbents capable of obtaining stable carbon dioxide gas absorption properties over a long period of time, methods for manufacturing the same, and methods for regenerating the same.

TABLE 1

| | | Addition | Addition | | |
|---|---|---|---|---|---|
| | | Amount of | Ratio to | Initial | Absorption |
| | | Potassium | Lithium | Amount of | Maintenance |
| | | Silicate | Silicate | Absorption | Ratio |
| | Form | (g) | (mol %) | (wt %) | (%) |
| Example | Pellet | 6 | 5.8 | 28 | 94 |
| 1 | | | | | |
| Example | Pellet | 1 | 1.0 | 30 | 90 |
| 2 | | | | | |
| Example | Pellet | 20 | 19.4 | 27 | 97 |
| 3 | | | | | |
| Example | Pellet | 30 | 29.1 | 25 | 99 |
| 4 | | | | | |
| Example | Pellet | 40 | 38.8 | 18 | 98 |
| 5 | | | | | |
| Example | Pellet | Sodium | 11.8 | 25 | 94 |
| 6 | | Silicate 6 | | | |
| Example | Granule | 6 | 5.8 | 28 | 94 |
| 7 | | | | | |
| Example | Granule | 1 | 1.0 | 31 | 90 |
| 8 | | | | | |
| Example | Granule | 20 | 19.4 | 27 | 96 |
| 9 | | | | | |
| Example | Film | 20 | 19.4 | 27 | 95 |
| 10 | | | | | |
| Example | Film | 6 | 5.8 | 29 | 93 |
| 11 | | | | | |
| Example | Film | 30 | 29.1 | 26 | 99 |
| 12 | | | | | |
| Example | Powder | 6 | 5.8 | 28 | 94 |
| 13 | | | | | |
| Example | Pellet | 50 | 48.5 | 13 | 99 |
| 14 | | | | | |
| Example | Granule | 50 | 48.5 | 14 | 99 |
| 15 | | | | | |
| Example | Film | 50 | 48.5 | 14 | 99 |
| 16 | | | | | |
| Com- | Pellet | — | — | 30 | 80 |
| parative | | | | | |
| Example | | | | | |
| 1 | | | | | |

TABLE 2

| | | Addition | | | |
|---|---|---|---|---|---|
| | | Amount of | Addition | | Absorp- |
| | | Potassium- | Ratio | Initial | tion |
| | | based | to | Amount | Mainte- |
| | | Water- | Lithium | of | nance |
| | | Glass | Silicate | Absorption | Ratio |
| | Form | (g) | (mol %) | (wt %) | (%) |
| Example 17 | Pellet | 9 | 5.6 | 28 | 93 |
| Example 18 | Pellet | 1.2 | 0.7 | 30 | 89 |
| Example 19 | Pellet | 32 | 19.9 | 27 | 96 |
| Example 20 | Pellet | 48 | 29.8 | 25 | 98 |
| Example 21 | Pellet | 60 | 37.3 | 18 | 97 |
| Example 22 | Pellet | Sodium- | 6.2 | 24 | 93 |
| | | based | | | |
| | | Water | | | |
| | | Glass 9 | | | |
| Example 23 | Granule | 9 | 5.6 | 28 | 93 |
| Example 24 | Granule | 1.2 | 0.7 | 31 | 89 |
| Example 25 | Granule | 32 | 19.9 | 27 | 95 |
| Example 26 | Film | 32 | 19.9 | 27 | 94 |
| Example 27 | Film | 9 | 5.6 | 29 | 90 |
| Example 28 | Film | 48 | 29.8 | 26 | 98 |
| Example 29 | Powder | 9 | 5.6 | 27 | 93 |
| Example 30 | Pellet | 80 | 49.7 | 13 | 98 |
| Example 31 | Granule | 80 | 49.7 | 14 | 98 |
| Example 32 | Film | 80 | 49.7 | 15 | 98 |

TABLE 1

| | Ratio of Contained | Absorption Amount |
|---|---|---|
| | Water | of Carbon |
| | (wt %) | Dioxide Gas (wt %) |
| Example 33 | 12 | 19 |
| Example 34 | 20 | 20 |
| Example 35 | 7 | 14 |
| Example 36 | 12 | 16 |
| Example 37 | 1.0 | 12 |
| Example 38 | 1.2 | 13 |
| Comparative | 28 | 8 |
| Example 2 | | |
| Comparative | 0.4 | 9 |
| Example 3 | | |
| Comparative | 9 | 8 |
| Example 4 | | |

The relevant contents of each of the above-identified references, patents, applications and published applications are hereby incorporated by reference, the same as if set forth at length.

Additional advantages and modifications will readily occur to those skilled in the art. Therefore, the invention in its broader aspects is not limited to the specific details and representative embodiments shown and described herein.

Accordingly, various modifications may be made without departing from the spirit or scope of the general inventive concept as defined by the appended claims and their equivalents.

What is claimed is:

1. A carbon dioxide gas absorbent, comprising:
at least one compound selected from the group consisting of sodium silicate, potassium silicate, and a combination thereof; and
lithium silicate.

2. The carbon dioxide gas absorbent according to claim 1, wherein the compound is present in said absorbent in an amount ranging from not less than 1 mol % to not more than 40 mol %.

3. The carbon dioxide gas absorbent according to claim 1, further comprising water in an amount of not less than 0.5 wt %, based on the weight of the absorbent.

4. The carbon dioxide gas absorbent according to claim 1, further comprising water in an amount of not less than 8.5 wt %, based on the weight of the absorbent.

5. The carbon dioxide gas absorbent according to claim 1, wherein the lithium silicate comprises Li₄SiO₄.

6. The carbon dioxide gas absorbent according to claim 1, further comprising at least one alkali carbonate selected from the group consisting of lithium carbonate, sodium carbonate, potassium carbonate, and a combination thereof.

7. The carbon dioxide gas absorbent according to claim 6, wherein the alkali carbonate is present in said absorbent in an amount ranging from not less than 0.5 mol % to not more than 40 mol %.

8. A carbon dioxide gas absorbent, comprising:
at least one compound selected from the group consisting of sodium-based anhydrous water glass, potassium-based anhydrous water glass, and a combination thereof; and
lithium silicate.

9. The carbon dioxide gas absorbent according to claim 8, wherein the compound is present in said absorbent in an amount ranging from not less than 1 mol % to not more than 40 mol %.

10. The carbon dioxide gas absorbent according to claim 8, further comprising at least one compound selected from the group consisting of sodium silicate, potassium silicate, and a combination thereof.

11. The carbon dioxide gas absorbent according to claim 8, further comprising water in an amount of not less than 0.5 wt %, based on the weight of the absorbent.

12. The carbon dioxide gas absorbent according to claim 8, further comprising water in an amount of not less than 8.5 wt %, based on the weight of the absorbent.

13. The carbon dioxide gas absorbent according to claim 8, wherein the lithium silicate comprises Li₄SiO₄.

14. The carbon dioxide gas absorbent according to claim 8, further comprising at least one alkali carbonate selected from the group consisting of lithium carbonate, sodium carbonate, potassium carbonate, and a combination thereof.

15. The carbon dioxide gas absorbent according to claim 14, wherein the alkali carbonate is present in said absorbent in an amount ranging from not less than 0.5 mol % to not more than 40 mol %.

16. A method of manufacturing a carbon dioxide absorbent, comprising:
mixing lithium carbonate and silicon dioxide to form a first mixture;
contacting the first mixture with a solution to form a second mixture, wherein the solution comprises at least one compound selected from the group consisting of sodium-based anhydrous water glass, potassium-based anhydrous water glass, and a combination thereof;
forming a pellet, a granule, or a film from the second mixture; and heating the pellet, the granule, or the film.

17. The method according to claim 16, wherein the compound is present in said solution in an amount ranging from not less than 1 wt % to not more than 60 wt %, based on the weight of the solution.

18. A method of manufacturing a carbon dioxide absorbent, comprising:
mixing lithium carbonate and silicon dioxide to form a first mixture;
heating the first mixture to form a heated first mixture;
mixing the heated first mixture and a solution to form a second mixture, wherein the solution comprises at least one compound selected from the group consisting of sodium-based anhydrous water glass, potassium-based anhydrous water glass, and a combination thereof; and
forming a pellet, a granule, or a film from the second mixture.

19. The method according to claim 18, wherein the compound is present in an amount ranging from not less than 1 wt % to not more than 60 wt %.

20. A method of regenerating a carbon dioxide gas absorbent, comprising:
heating the carbon dioxide gas absorbent at a temperature of 350° C. to 1000° C.;
cooling the carbon dioxide gas absorbent in an atmosphere which does not contain dioxide gas; and
contacting the carbon dioxide gas absorbent with an atmosphere comprising water vapor but which does not contain carbon dioxide gas,
to obtain a carbon dioxide gas absorbent comprising:
at least one compound selected from the group consisting of sodium silicate, potassium silicate, and a combination thereof;
lithium silicate; and
a water content of not less than 0.5 wt % based on the weight of the absorbent.
